(19) United States
(12) Patent Application Publication
(10) Pub. No.: US 2026/0119822 A1
(43) Pub. Date: Apr. 30, 2026

(54) MULTI-MODAL TRANSLATION MANAGEMENT AND PRESENTATION

(71) Applicant: Katherine Lapides-Lees, Austin, TX (US)

(72) Inventor: Katherine Lapides-Lees, Austin, TX (US)

(21) Appl. No.: 19/373,181

(22) Filed: Oct. 29, 2025

Related U.S. Application Data
(60) Provisional application No. 63/714,599, filed on Oct. 31, 2024.

(51) Int. Cl. G06F 40/58; G06F 3/0482; G06F 3/0484

(52) U.S. Cl. CPC G06F 40/58; G06F 3/0482; G06F 3/0484

(57) ABSTRACT

The disclosed computer program product and method of use provides a system for managing, controlling, and displaying multi-modal translations of digital content through a structured system which includes both moderator and user interfaces. This system and method permits a moderator to isolate portions of digital content, and to upload various translations thereof. A plug-in module provides a translation display window that allows a user to select from and control visual and/or auditory representations of the translation from a variety of languages as well as request additional translations be provided.

### TECHNICAL FIELD

This disclosure relates generally to multi-modal translation management, and more particularly to systems, methods, and products for presenting a user with multi-modal translations of digital content displayed on devices with an interactive electronic display.

### BACKGROUND

In an increasingly globalized world, communication across language boundaries has become essential. This is particularly true in the modernized world where computers and other similar technologies have become a necessary aspect of being a part of society. In fact, the use of computers is an almost necessary aspect for communication, work, education, banking, healthcare, shopping, entertainment, navigation and travel, access to news and information, and other elements of modern society.

Language barriers present significant challenges in today's modern world, particularly when effective communication across diverse languages is increasingly necessary. Despite the importance of digital communication, language differences and language barriers often limit access to information, complicate conversations, and make it difficult for individuals with language accessibility issues to participate in digital communications. These barriers may prevent individuals from fully accessing essential services online, may cause significant economic and professional barriers, and even result in inequality and social exclusion issues.

Addressing language barriers requires intentional integration of multilingual support into systems services and technologies to ensure inclusive and efficient communication across a multilingual world. This multilingual support should address not only written language barriers but also be inclusive of inherently visual and auditory forms of communication including sign language and spoken translations.

Although existing translation software has made great strides with advancements in artificial intelligence and language processing, several limitations exist. For example, artificial intelligence may struggle to fully understand the context of sentences or conversations, resulting in incorrect or awkward translations when the software cannot comprehend the intended context. Likewise translations between languages with varying syntax complexity or grammatical structures may result in unnatural or confusing sentence structures of the translated language. Existing software also may struggle to manage nuanced or cultural expressions, resulting in further awkward or incorrect translations. In addition, existing translation software may struggle with rare or more complex languages, struggle to decipher from formal to informal language variations, and may only be available for languages coded into the existing software.

Current sign language translation software also faces unique limitations due to the complexity and visual nature of sign languages. For example sign languages often have their own unique grammar syntax and spatial structures that may differ fundamentally from spoken languages. Likewise facial expressions and body language are a crucial part of conveying information via sign language. Also, just like spoken languages, sign languages may vary between regions and include various dialects. As such, a sign language interpretation provided for a website in American Sign Language may be difficult for an individual fluent in British Sign Language to understand, or at a minimum certain information may be incorrectly conveyed or lost in translation.

Another issue with current translation software is it often only provides a single form of translation services. For example, some translation software uses artificial intelligence to automatically translate all the text on a given website from a first language to a second language. However this software is unable to also provide a translation of other sorts of digital content on the website, such as video or audio recordings. In this instance, an individual may be able to read the translated information provided on the website, but is prevented from understanding what is being spoken in an embedded video. Likewise, some people may speak one language fluently, but are only able to read in a second different language. When there are mixed forms of digital content on a website for translation, translation to a single language may not be sufficient.

Another limitation with existing software is that it is often difficult to implement into existing forms of digital content. For example, some more complex translation software services require that the website be built around the translation service, as opposed to being added to the website at a later time. This limits the ability to use this technology for existing websites. Likewise existing translation software typically relies on both artificial intelligence translations and human translators, typically relying either on the translation software companies' translators or a third party translating service to provide and manage the translations. Despite the use of human translators playing a vital role in providing website and digital media translations, there is a whole other unique set of issues created by forcing website owners to rely on third party translations. By way of example, the website owner may not have any control over the quality of the translations, or the translations provided may lack contextual understanding. Further, by requiring the website owner to rely on a third party translator, the time between when the content is uploaded to the website and when a translation becomes available may vary depending on the speed in which the translator service operates. Additionally, by relying on a third party service for translations, this may add a further degree of separation between a small business owner and potential clients.

### SUMMARY OF THE INVENTION

The present disclosure addresses many of the challenges and/or problems discussed above related to language barriers. In some embodiments, a multimodal translation management software plugin and method of use thereof is provided. According to some embodiments, this software plugin module can be easily integrated into existing digital media including but not limited to websites, applications, vehicle computers, and anywhere else where digital information is presented on an interactive screen.

In some embodiments, the presently disclosed software and method of use includes a moderator interface for the website or digital media owner to manage available translations. In some instances, the moderator interface may allow the owner to view the digital content on the website in the native form. While viewing the content in the native form, the moderator interface may identify and isolate individual portions of digital content. Once isolated, the moderator may upload translations to the moderator interface and link specific translations to specific digital content. In some embodiments, the moderator can choose where and how the translations are displayed to ensure that the translations do not interfere with the existing user interface on the website, thus providing a level of customization not found in the prior art.

In certain other embodiments, a software plugin module may also include a user interface aspect. The user interface may be a distinct interface accessed by the public or the user of the specific device or website. According to some embodiments, a universally recognizable translation button may be presented on the user interface indicating to a user that translations are available for certain digital content. Upon pressing the translation button, the website user may choose specific pieces of digital content for translation. In some embodiments, the software plugin module may be designed so that once a user chooses a piece of digital content for translation, a moveable & expandable translation display window is displayed over the native format of the content on the device. Using the translation display window, the user may select from the available translations which language translations they wish to view, how the translations are viewed and control the playback of the translations in real time. Likewise the user may request additional translations, flag incorrect translations for the moderator to review, or report other issues with the available translations.

In certain embodiments the present disclosure also contemplates a notification system wherein the moderator may receive notifications when translations are requested or other playback issues occur, and the user may receive notifications when certain translations are uploaded or corrected.

Embodiments of the present disclosure may include a software plugin module and method of use thereof for providing multi-modal translation services to existing digital content. More specifically, according to some embodiments, the presently disclosed software plugin module may permit a website moderator to control which translations are uploaded and which pieces of digital content the specific translations are associated with. Likewise the presently disclosed software plugin module may permit the user to decide which of the associated translations they wish to view and to control how the chosen translations are presented on the user interface.

### DESCRIPTION OF THE DRAWINGS

FIG. 1 illustrates a diagram showing an overview of a configuration of the information processing system of the presently disclosed multi-modal translation management system according to one embodiment.

FIG. 2 illustrates an example of a configuration of a moderator interface of the presently disclosed multi-modal translation management system according to one embodiment.

FIG. 3 illustrates an example of a first configuration of a user interface of the presently disclosed multi-modal translation management system according to one embodiment.

FIG. 4 illustrates an example of a second configuration of a user interface of the presently disclosed multi-modal translation management system according to one embodiment.

FIG. 5 illustrates an example of a third configuration of a user interface of the presently disclosed multi-modal translation management system according to one embodiment.

FIG. 6 illustrates an example of a fourth configuration of a user interface of the presently disclosed multi-modal translation management system according to one embodiment.

FIG. 7 illustrates an example of a fifth configuration of a user interface of the presently disclosed multi-modal translation management system according to one embodiment.

FIG. 8 illustrates an example of a sixth configuration of a user interface of the presently disclosed multi-modal translation management system according to one embodiment.

FIG. 9 illustrates an example of a seventh configuration of a user interface of the presently disclosed multi-modal translation management system according to one embodiment.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

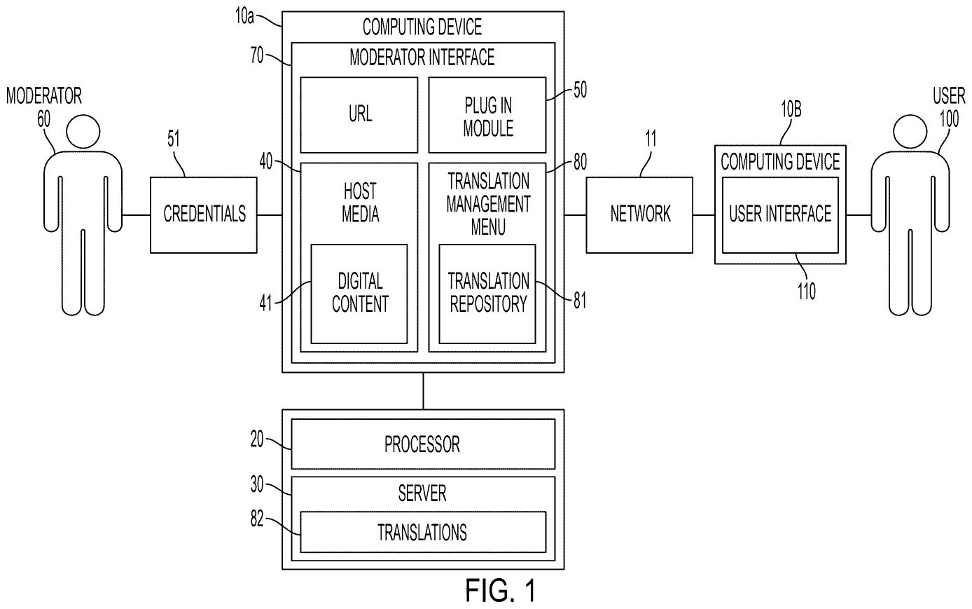

As shown in FIG. 1, various embodiments of a system, device or method described herein includes one or more computing devices 10(a), 10(b). The computing device 10(a), 10(b) may be any suitable computing device (such as a server) that may include at least one processor 20 and at least one memory device such as a server 30. As further described herein, the computing device 10(a) may include at least one processor 20 configured to transmit and receive data or signals representing events, messages, commands, or any other suitable information between the computing device 10(a) and other devices. The processor 20 of the computing device 10(a) may be configured to execute the events, messages, or commands represented by such data or signals in conjunction with the operation of the computing device 10(a) as exemplified herein. One outcome of the use of a computing device 10(a) may result in the display of a host media 40 on a first computing device 10(a). In some embodiments, the host media 40 may include various types of digital content 41 which may include web pages or other digital content 41.

The term digital content 41 as used herein may refer generally to the various types of media commonly displayed on a website or other forms of host media 40, including text, videos, audio recordings, files, and images. Other forms of host media 40 and digital content 41 are also contemplated by this disclosure, including augmented reality and live streams of video footage or radio broadcasts.

In additional embodiments, the digital content 41 may include content accessible through scannable or machine-readable codes, such as a QR code, barcode, or near-field communication (NFC) tag. For example, a user 100 may scan a QR code displayed on a product, sign, menu, or packaging using a mobile device or kiosk equipped with the presently disclosed software plugin module 50. Upon scanning, the corresponding digital content 41 may be retrieved from a server 30 or web-based host media 40 and rendered through a first computing device 10(a) or second computing device 10(b), as will be described in more detail herein.

Such digital content 41 may include, for instance, digital restaurant menus, nutritional labels, ingredient lists, allergen warnings, instructional guides, or digital warnings associated with cleaning supplies, medicines, industrial chemicals, hazardous materials, electrical equipment, mechanical tools, building materials, automotive fluids, pesticides, or other consumer and commercial products requiring cautionary or safety information.

In certain implementations, the presently disclosed system may automatically detect the language of the scanned digital content 41 and provide instantaneous translation to be displayed on a user's 100 computing device 10(b). The user 100 may also selectively interact with the retrieved digital content 41 through the user interface 110—for example, to request additional information, or toggle between different translation or accessibility display modes, as will be described in more detail herein. This functionality enables the presently disclosed system to provide real-time, context-sensitive translation and accessibility support for physical-world materials linked to digital content through scannable identifiers.

In some embodiments, a computing device 10(a) may utilize a software plugin module 50. A software plugin module 50 is one method of adding functionality to existing host media 40 without necessitating the host media 40 being completely rewritten or redesigned. Often, software plugin modules 50 are added to the host media 40 after it is written, and typically supplement existing functionality of the host media 40. Disclosed herein is a software plugin module 50 and method of use thereof for providing multimodal translation services to existing host media 40.

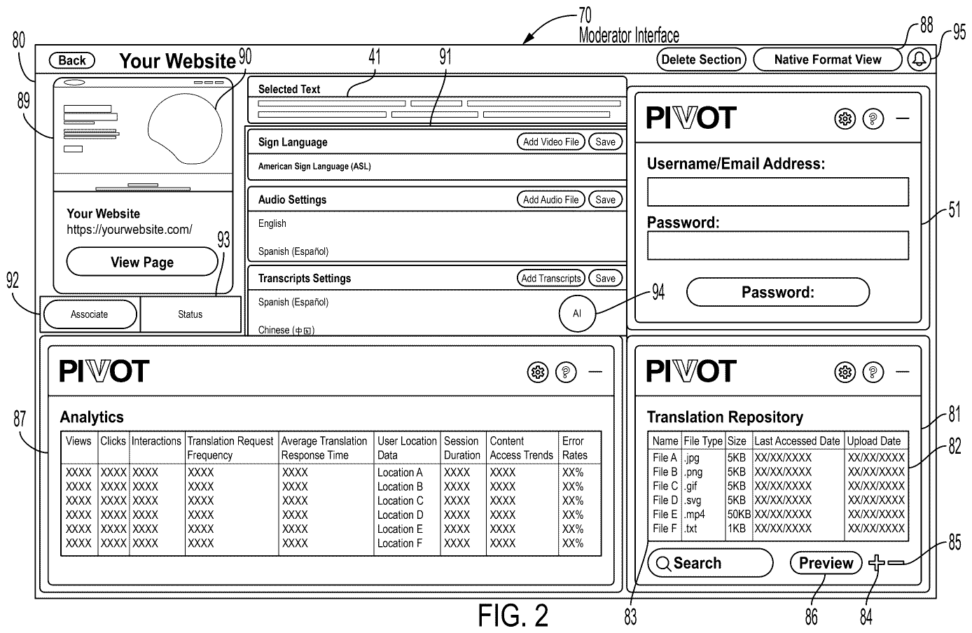

In some examples, host media 40 may be customized, written, controlled, managed, or updated by a moderator 60 using a moderator interface 70, as depicted in FIG. 2. In some embodiments, the software plugin module 50 is designed to provide the moderator 60 of the host media 40 a translation management menu 80 within a moderator interface 70 to permit the moderator 60 to incorporate additional translation functionality and capabilities into the host media 40. In some embodiments, the plugin module 50 lets the moderator 60 manage a translation repository 81 through the translation management menu 80 for the host media 40 which may include one or more translations 82 stored on the server 30 of the computing device 10(a).

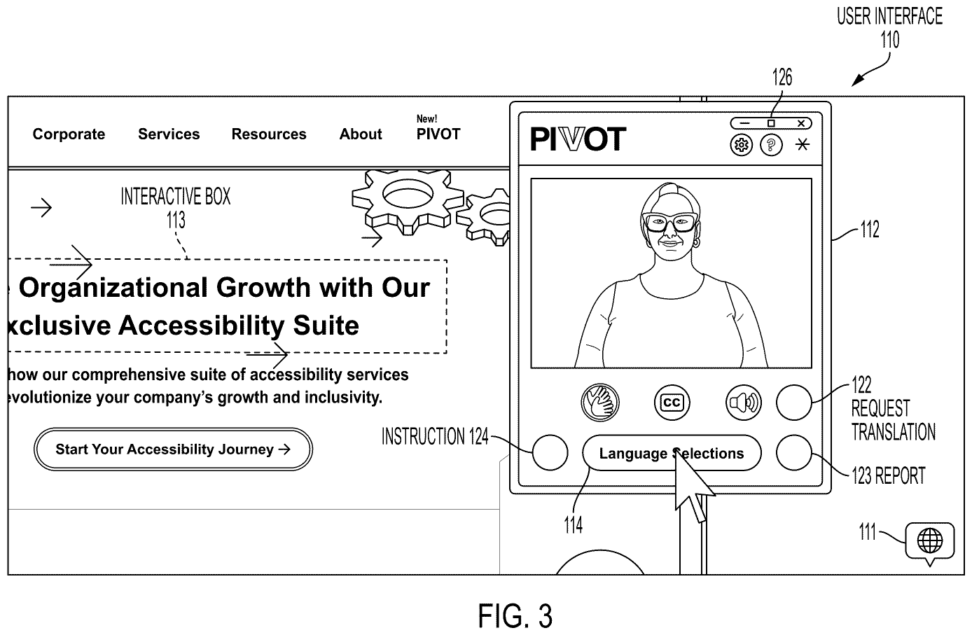

The moderator interface 70 may be displayed and available for interactions with the moderator 60 on a first computing device 10(a). In some embodiments, a similar interface exists for a user 100 to also view and interact with the host media 40 and digital content 41 through the user interface 110 on a second computing device 10(b), as depicted in FIG. 3. Although the present example depicts the second computing device 10(b) as a computer, it is recognized that the second computing device 10(b) may include any device capable of displaying a host media 40 and associated digital content 41, including, without limitation, mobile cellular device, a vehicle-based infotainment system, an augmented or mixed reality device, a kiosk, a vending machine, a telephone, a tablet computer, a laptop, a desktop computer, a smart television, a wearable device (e.g., smartwatch, smart glasses, or fitness tracker), a gaming console, a digital signage display, or any other electronic device equipped with a user interface 110 and capable of network communication. In some embodiments, the software plugin module 50 may supplement the code to the host media 40 which results in a user interface 110 on the second computing device 10(b) with added functionality for viewing, controlling, and requesting various forms of translations 82 for some or all of digital content 41 displayed on the host media 40.

In some embodiments, the information necessary to display the host media 40 may be stored in a server 30 connected to a first computing device 10(a). In the present example depicted in FIG. 1, the host media 40 may be a website which a user 100 may view and interact with on a second computing device 10(b). In some embodiments, when a user 100 wishes to view host media 40 such as a website on their computing device 10(b), several processes may occur in order for the second computing device 10(b) to retrieve and display the requested host media 40 and digital content 41.

A user 100 may enter a uniform resource locator (URL) into a browser or use a cursor to select a link that directs to the URL. A URL contains certain information such as the domain name, and may optionally specify a particular resource or function contained within the host media 40, such as displaying a specific piece of digital content 41 or redirecting the user 100 to a different host media 40. When a user 100 enters the URL into the browser, the browser, which may be installed directly on the second computing device 10(b), performs a domain name system (DNS) lookup to convert the URL into an internet protocol (IP) address. Once the browser has the IP address, the browser may then initiate a direct connection to the server 30 or database contained therein in which the code for the host media 40 is stored through a network 11. This connection may occur may include, without limitation, any wired or wireless communication network 11 such as a local area network (LAN), a wide area network (WAN), a metropolitan area network (MAN), the Internet, a cellular network (e.g., 3G, 4G, 5G, or subsequent generations), a satellite network, a fiber-optic network, a coaxial or Ethernet-based network, a Bluetooth or near-field communication (NFC) network, a Wi-Fi or WiMAX network, a radio-frequency (RF) network, or any combination thereof. In some embodiments, the network 11 may further include virtual private networks (VPNs), cloud-based data networks, or mesh networking configurations that facilitate data transmission between the server 30 of the first computing device 10(a) and the second computing device 10(b). Once a direct connection between the browser and server 30 is established, the browser may send a hypertext transfer protocol (HTTP) to the server 30 which recalls the specific resource which may include host media 40 and any associated digital content 41.

The server 30 in which the website or host media 40 is stored then receives the request from the browser and processes it. During processing, the server 30 may retrieve stored files for the digital content 41 and/or interact with a separate database stored on a separate server 30 to dynamically generate content. Then, using the code for the requested website, the server 30 assembles all the necessary components for the host media 40 such as the hypertext markup language (HTML) structure, the various styling components, and any additional digital content 41. Once the server 30 has processed the request, it sends back, via the network 11 an HTTP response to the browser which includes information for rendering the requested host media 40 and associated digital content 41. Upon receiving the information from the server 30, the browser loads the requested information onto the second computing device 10(b) and applies the various styling options to display the host media 40 and associated digital content 41 which may then be displayed on or through the user interface 110. In some instances, as the user 100 interacts with the host media 40, through the user interface 110 such as clicking links, filling out forms, or initiating playback of digital content 41, the browser automatically and continuously sends requests and receives information back from the server 30 over the network 11. This process happens rapidly and allows a user 100 to interact with the host media 40 in near-real time to display interactive digital content 41 through the user interface 110.

In some embodiments of the present disclosure, a software plugin module 50 may be designed to be embedded into existing host media 40. Typically, a software plugin module's 50 code integrates directly into a host media's 40 existing code to supplement functionality. In some embodiments, the software plugin module 50 may include its own independent set of code files that live alongside the main host media's 40 code, but the software plugin module's 50 code is not rewritten directly into the host media's code. According to some embodiments, the code for the software plugin module may be stored on a server 30 of either the first computing device 10(a) or another server 30 connected to the first computing device 10(a) via the network 11. In some instances, a software plugin module's 50 code remains dormant while a user 100 interacts with the host media 40 through the user interface 110 until the user 100 performs an action that initiates the software plugin module's 50 activity. In the example where the host media 40 is a website displayed on a second computing device 10(b), a user's 100 action could include clicking an icon overlaid the website, pressing a certain keystroke combination, or meeting a certain activity threshold on the website. Upon activation of the software plugin module 50, certain supplemental functionality contained within the code of software plugin module 50 becomes available for the user 100 to interact with on the user interface 110, and/or the moderator 60 to interact with on the moderator interface 70. Exemplary software plugin modules 50 are designed to seamlessly integrate into existing host media 40 while simultaneously providing additional functionality related to the digital content 41 not originally contemplated in the native format of the host media 40. In some instances, software plugin modules 50 are intended to add additional features to the user interface 110 of the host media 40, or to add additional features to the moderator interface 70 to control or customize the host media 40. In other instances, software plugin modules 50 may be designed to improve website performance, integrate third-party services, enhance website security and/or customize the user experience by improving the accessibility of the user interface 110. Certain exemplary software plugin modules 50 may incorporate one or more of these functionality features for the user interface 110. In some instances, the added functionality of the software plugin module 50 may include connecting host media 40 displayed on a second computing device 10(b) to a server 30 through a network 11 and presenting information, such as translations 82 from that database on the user interface 110 of an existing host media 40 for a user 100 to view and interact with.

In addition to adding functionality on the user interface 110 side of a specific host media 40, software plugin modules 50 may also significantly enhance the features or functionality of a moderator interface 70. In some embodiments, enhancements to the moderator interface 70 from software plugin modules 50 may include the addition of new tools and functionalities that streamline tasks, improve content management, track statistics, and increase moderator customization for a given host media 40. In the present example, depicted in FIG. 2, the moderator interface 70 is an interface designed specifically for a moderator 60 to manage and monitor a website and the digital contented 41 displayed therein.

The moderator interface 70, depicted in FIG. 2, is usually hidden from regular users and may include tools for content moderation, user management, and overall website oversight. In most instances, the moderator interface 70 is only accessible to people with specific roles or permissions granted by the owner of the host media 40, and allows the website moderator 60 to keep the host media 40 safe, organized, and engaged for users. Certain software plugin modules 50 may provide moderators 60 the necessary control over the host media 40 so that the moderator 60 does not require a third party to update the content on host media 40.

In some embodiments, such as the example depicted in FIG. 2, the software plugin module 50 may require credentials 51 for access to the moderator interface 70. These credentials 51 may include usernames, emails, passwords, security questions, push notifications, or other forms of verification. By requiring credentials 51 to access the moderator interface 70, the owner of the host media 40 may ensure only authorized moderators 60 can access sensitive data or make changes to host media 40 and user interface 110. The use of credentials 51 also helps prevent unauthorized access to the moderator interface 70, protects confidential information, and prevents against data breaches, while also allowing the owner of the host media 40 to track and manage analytics about moderator 60 activity within the moderator interface 70.

Unlike the moderator interface 70, which is the portion of the website for managing host media 40, the user interface 110, as depicted in FIG. 3 is the visual and interactive aspect a user 100 interacts with on the host media 40. User interfaces 110 may have their own set of important features to ensure that website visitors can interact smoothly with the digital content 41 contained within a host media 40. In some embodiments, a user interface 110 may include the visual layout that allows users 100 to navigate, interact, and engage with the website's content. This includes certain essential elements such as menus, buttons, search bars, forms, visual design components such as colors and typography, and various other forms of digital content 41, including those disclosed previously.

According to some embodiments, the presently disclosed software plugin module 50 and system of use thereof is designed to incorporate additional functionality into both the user interface 110 and moderator interface 70 of a host media 40. FIG. 2 depicts one example of the added functionality of the software plugin module 50, as viewed from the moderator interface 70 when added to an existing host media 40. In this example, the software plugin module 50 supplements the host media's 40 functionality by seamlessly providing an additional translation management menu 80 to the existing moderator interface 70. According to some embodiments, the software plugin module's 50 translation management menu 80 may be designed to allow a moderator 60 to manage and control which translations 82 are available for each specific piece of digital content 41 displayed on a host media 40. To achieve this, the software plugin module's 50 translation management menu 80 includes numerous tools and functions which, when implemented into host media 40 code, provides the moderator 60 control over which translations 82 are made available for each distinctive piece of digital content 41.

According to some embodiments, one tool for managing the translations 82 of digital content includes a translation repository 81. The translation repository 81 may be a section or dedicated page available on the translation management menu 80 of the moderator interface 70 where the moderator 60 can access, download, upload, and manage translation files 83 for storing specific translations 82 relevant to the host media's 40 content or purpose. In some embodiments, the translation files 83 which are maintained within the translation repository 81 may include media files for images (including .jpg, jpeg, png, gif, .svg, and .webp files), videos (including. mp4, .webm, .avi, and .mov), and audio (including mp3, wav, and aac), document files (including .pdf, .txt, and .md), and other sorts of data files (including .xml, json, and .csv). In certain embodiments, any type of file in which a translation 82 can be stored on may be uploaded into the translation repository 81. In some embodiments, the translations repository 81 of the software plugin module 50 may display a list of available translation files 83, including but not limited to specific details for each file 83 such as the name, file type, size, last accessed date, and upload date. In some embodiments, the list of the translation files 83 within the translation repository 81 may be organized into categories or folders to make it easier for the moderator 60 to locate specific translation files 83. The translation repository 81 may also include search and filter options that allow the moderator 60 to search the available translation files 83 within the translation repository 81 by keyword, file type, date, or any other category. The translation file repository 81 also may include an uploading tab 84 for uploading additional translation files 83, as well as an delete button 85 for deleting translation files 83 directly from the translation repository 81. In certain other embodiments the translation repository 81 may include a preview function 86 that enables the moderator 60 to view or listen to a translation 82 stored on a translation file 83 or a portion thereof without having to open or download the specific translation file 83.

According to some embodiments the translation repository 81 may also allow the moderator 60 to select and open a specific translation file 83 to view its contents in totality. The presently disclosed translation repository 81 may also include an activity log 87 which allows a moderator 60 to track which specific pieces of digital content 41 each translation file 83 is linked to through the software plugin module 50. In some embodiments, the moderator interface 70 may also permit a moderator 60 to collect analytics through the activity log 87, including, without limitation, user engagement metrics (e.g., number of views, clicks, and interactions), translation request frequency, average translation response time, user location data, session duration, content access trends, error or failure rates, device type and browser statistics, conversion rates, and other performance indicators associated with the host media 40 and digital content 41. In certain embodiments, such analytics may be presented in graphical or tabular format within the moderator interface 70 and may be exportable for further analysis or reporting. As will be described in more detail herein, the moderator interface 70, translation repository 81, and the presently disclosed software plugin module 50 are intended to be the components of the presently disclosure where translation files 83 are uploaded, stored, and managed by moderators 60.

In addition to the translation repository 81, the software plugin module 50 may include a native format view option 88 which permits the moderator 60 to view the host media 40 and associated digital content 41 in their native formats. As described previously, the software plugin module 50 is intended to supplement the functionality of an existing host media 40, rather than replace or modify existing functionality. One aspect of maintaining a host media's 40 native functionality is the ability of the moderator 60 to view the host media 40 and its functionality in the native format. To do this, the plugin software module 50 may retrieve the code for the host media 40 from the server 30 via the network 11 and display an augmented view of the host media 40 in its native format through the moderator interface 70. When viewed in the native format, the host media may be is displayed with its native functionality on the moderator interface 70 exactly how it would be viewed through the user interface 110.

The translation management menu 80 also may include a digital content isolation tool 89. While viewing the host media 40 through the native format view option 88 on the moderator interface 70, a moderator 60 may use the digital content isolation tool 89 to identify and isolate the various aspects of digital content 41 contained within the native format of a host media. According to some embodiments, the digital content isolation tool 89 is an aspect of the software plugin module 50 designed to automatically scan the front-end languages of the native format of a given host media 40. As the digital content isolation tool 89 scans the front-end languages of the native host media 40, the software plugin module 50 is designed to identify and isolate specific sections of digital content 41 contained within the native format of a particular host media 40. After the digital content isolation tool 89 scan is completed, the digital content isolation tool 89 of the software plugin module 50 is designed to display an augmented view of the native format of a host media 40 with each piece of digital content 41 including a selectivity icon 90. In some other embodiments, rather than a selectivity icon 90, a different notification system may be used to alert the moderator 60 that a particular piece of digital content 41 has been identified and isolated, including a popup notification, a highlight around the digital content, and other various notification means.

Upon pressing the selectivity icon 90 or other notification means, a content selection panel 91 may be presented onto the moderator interface 70. The content selection panel 91 may be designed to allow the moderator 60 to link a specific translation file 83 from the translation repository 81 to a specific piece of digital content 41. In some embodiments the content selection panel 91 may include a drop down menu or a window panel that displays all the available translations 82 from the translation repository 81. Like the translation repository 81, the content selection panel 91 may display a list of available translation files 83, including details such as the name, file type, size, and upload date. Likewise, the list of the translation files 83 displayed on the content selection panel 91 may be organized into categories or folders to make it easier for the moderator 60 to locate specific translation files 83, and the content selection panel 91 may also include search and filter options that allow the moderator 60 to search the available translation files 83 within the translation repository 81 by keyword file type date or category. In certain embodiments the content selection panel 91 may include a side by side display field, displaying on one side the specific piece of isolated digital content 41 (or a preview thereof), and on the other side a specific chosen translation 82 (or a preview thereof). The content selection panel 91 may also include a translation type drop menu with options including various types of translations 82 such as a sign language translation, an auditory translation, a text or closed-caption translation, and/or other available types of translations 82. Once the moderator 60 selects a certain piece of isolated digital content 41, the moderator 60 may then select a translation file 83 from the translation repository 81 to link the specific translation 82 to the specific piece of digital content 41.

After selecting the specific piece of digital content 41 for translation and the associated translation file 83, the moderator 60 may then choose the type of translation 82 represented in the associated translation file 83 from the translation type drop down menu. The final step for linking a specific translation file 83 to a particular piece of digital content 41 requires the moderator 60 to review the selected translation 82 and to approve the association by pressing an associate key 92. Once completed, the content selection panel 91 may automatically close or remain open, and the software plugin module 50 saves the association of the specific translation file 83 to the specific digital content 41 which is then made available for viewing and interaction as described herein on the user interface 110.

In certain embodiments, the content selection panel 91 may also include a status indicator 93 which displays the status of the translation 82 association for a specific piece of digital content 41. For example, the status indicator 93 may indicate “unassociated” when a specific piece of digital content 41 does not have an associated translation 82. In other examples, the status indicator 93 may read “associated successfully” when a specific translation 82 is linked to a specific piece of digital content 41, or indicate “error” when an association is saved but there is an error in the association or the translation file 83.

In certain other embodiments, the content selection panel 91 may also include an artificial intelligence key 94 for automating translations 82 using artificial intelligence. In these embodiments, the moderator 60 may direct the software plugin module 50 to automatically provide an artificial intelligence-generated translation 82 for the specific digital content 41. This feature may be particularly useful in instances where the host media 41 content is constantly changing, such as for forums or comment sections of a website. Rather than having to upload a new translation file 83 for each new post or comment on a particular page, the moderator 60 can choose to allow the software plugin module 50 to use artificial intelligence to provide a translation 82 of the specific digital content 41. In some embodiments, when the translation 82 for digital content 41 is created using the artificial intelligence key 94, separate notification is prompted onto the user interface 110 indicating to the user 100 that the chosen translation 82 was generated using artificial intelligence and may include errors. In some embodiments, a moderator 60 may provide their own translations 82 for specific digital content, while in other embodiments a moderator 60 may choose from an existing library of translation 82. If a moderator 60 choses multiple translations 82 for a single piece of digital content 41, each of the translations 82 will be available for the user 100 on the user interface 110.

The moderator interface 70 may also include other various tools in certain embodiments. For example, certain embodiments of the moderator interface 70 may include a notification pane 95 which may provide notifications to the moderator 60 in response to various user interface 110 actions. As will be described in more detail herein, the user interface 110 includes certain functionality allowing the user 100 to request specific translations 82 for certain digital content 41 on the user interface 110. When a request is made for supplemental translation, the notification pane 95 of the moderator interface 70 may include a notification indicating the specific details of the request. Likewise, in certain embodiments a user 100 may flag certain translations 82 as incorrect, or report other various playback issues such as volume issues, sound quality issues, and/or background noise issues. When this occurs, the moderator 60 may receive through the notification pane 95 of the moderator interface 70 a notification regarding the incorrect translation or other user interface 110 issues. According to some embodiments, the software plugin module 50 may include functionality designed to send notifications or alerts to the moderator 60 via e-mail, SMS, push notification, or other various notification means.

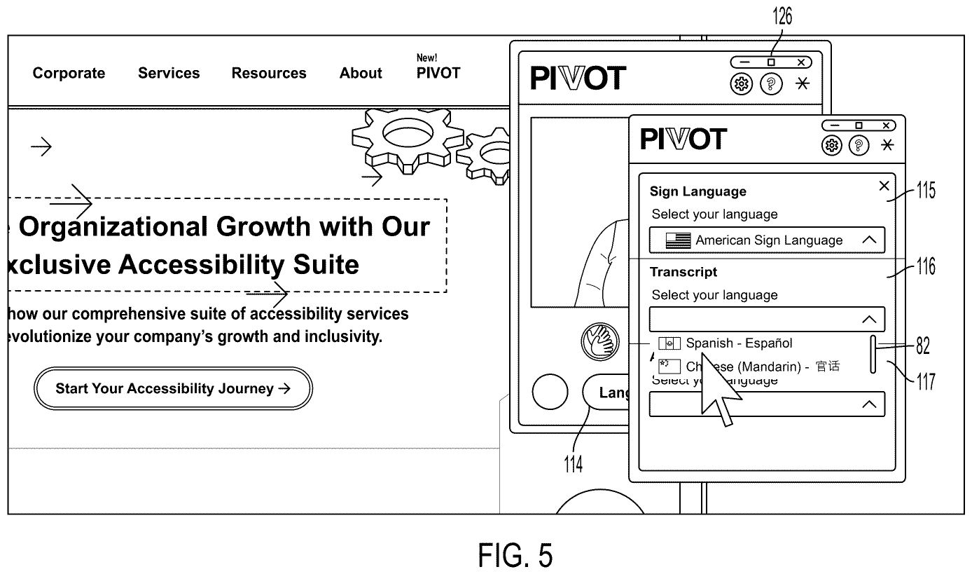

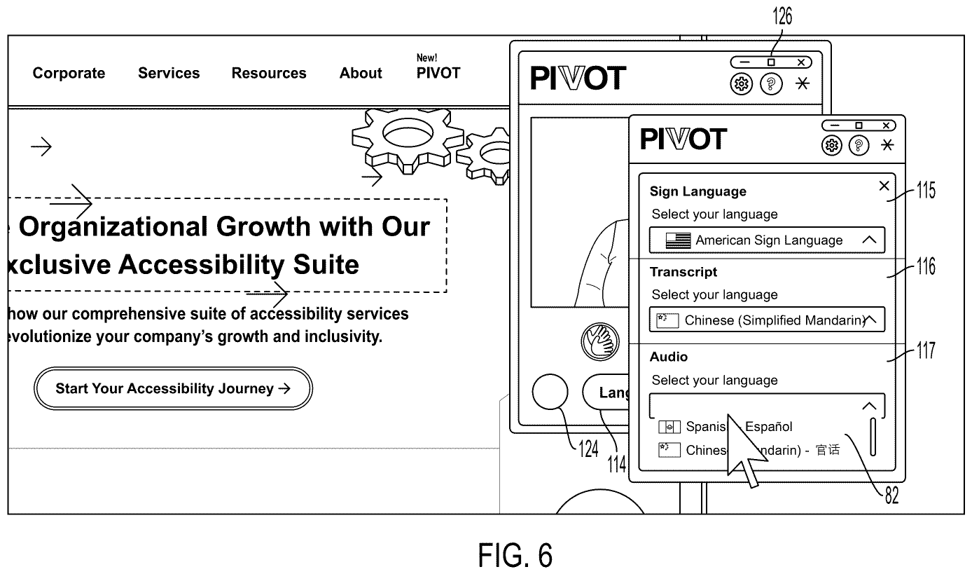

The user interface 110 aspect of the presently disclosed software plugin module, as depicted in FIGS. 3-9, includes a different set of tools and functions from the moderator interface 70. Unlike the moderator interface 70, which is designed for uploading, managing, and linking available translations 82 to specific digital content 41, the user interface 110 created by the presently disclosed software plugin module 50 is intended to add functionality for a user 100 to decide which translations 82 are displayed, and to control how the translations 82 are represented on the user interface 110.

FIG. 3 depicts an embodiment in which the host media 40 comprises a website having an associated user interface 110 configured to present digital content 41 and interactive elements to the user 100. According to some embodiments, websites that have incorporated the software plugin module 50 will include a universally recognizable translation availability icon 111 on the website indicating that translations 82 are available. Upon clicking the translation availability icon 111, a moveable translation display window 112 appears on the user interface 110 overlaid onto the existing native content of the host media 40. The translation display window 112 is designed to display one or more available translations 82 for any digital content 41 in which translations 82 have been provided by the moderator 60.

According to some embodiments, after activating the translation display window 112, the rest of the host media 40 remains in its native format. As the user 100 navigates their cursor over certain aspects of digital content 41, the availability of a translation 82 for the specific digital content 41 is provided by a notification to the user 100. In some embodiments, such as that depicted in FIG. 3, this may include the display of an interactive box 113 surrounding the specific digital content 41. Other methods of notifying a user 100 that translations are available for a specific piece of digital content 41 are also contemplated, including but not limited to the digital content 41 being highlighted, the color of the digital content 41 changing, the shape of the user's 100 cursor changing, and any other method of indicating that the specific digital content 41 has available translations 82. In some embodiments, the user 100 is only notified that the specific digital content 41 has available translations 82 when they move their cursor over the digital content 41. In other embodiments, all digital content 41 with available translations 82 on a given host media 40 may be immediately identified through the various notification methods. While the plugin software module 50 includes both notification functionalities, it is up to the moderator 60 and or user 100 to determine how the availability of translations 82 for specific digital content 41 is displayed on the user interface 110.

The translation display window 112, according to some embodiments, is a user interface 110 element designed to present translations 82 on the user interface 110 in a clear and user-friendly way. As such, there are several aspects of the translation display window 112 that allow a user 100 to control and optimize how specific translations 82 are presented. As described previously, the translation display window 112 may be activated upon the host media 40 user 100 pressing the translation availability icon 111. Once activated the translation display window 112 appears as an interactive window overlaid atop the host media's 40 native format. Because the translation display window 112 is controlled by the software plugin module 50, the presence of the translation display window 112 does not change the host media's 40 native functionality or display of information. According to some embodiments, the translation display window 112, once activated, is a movable window panel that includes a window control bar 126 to allow a user 100 to expand and minimize the size and shape of the translation display window 112, as well as an option for closing the window entirely. Likewise, the user 100 can move the translation display window 112 around the user interface 110 so that the translation display window 112 does not block certain portions of the native display of the host media 40.

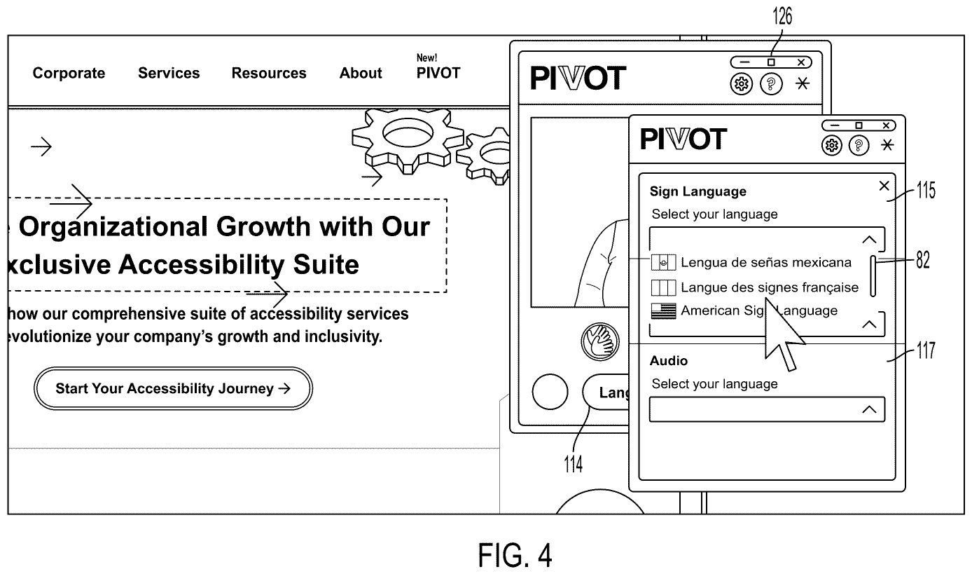

According to some embodiments, including the exemplary embodiment depicted in FIGS. 4-6, the translation display window 112 may include one or more translation option menus 114 listing the available translations 82 for a specific piece of digital content 41. The one or more translation option menus 114 may include a sign language translation dropdown menu 115, a transcription translation dropdown menu 116, an audio translation dropdown menu 117, and/or any other kind of translation dropdown menu. Each category of translation option menus 114 may list all the available translations 82 of a specific type (i.e. sign, audio, text, etc.) previously associated with the specific digital content 41 by the moderator 60 for the chosen type of translation 82. For example, in some embodiments, a moderator 60 may make available sign language translations 82 for a specific digital content 41 of a host media 40 in both American Sign Language and British Sign Language. From the sign language dropdown menu 115, the user 100 may choose which specific sign language translation 82 they want to be displayed on the translation display window 112. In another example, a moderator 60 may make available audio translations 82 for a specific piece of digital content 41 in English, Spanish, Chinese, and Russian. From the audio translation dropdown menu 117, the user 100 of the host media 40 may choose which translation 82 they wish to be played through the translation display window 112. After choosing the one or more translation(s) 82 from the one or more translation option menus 114, the selected translation(s) immediately and automatically populate the translation display window 112.

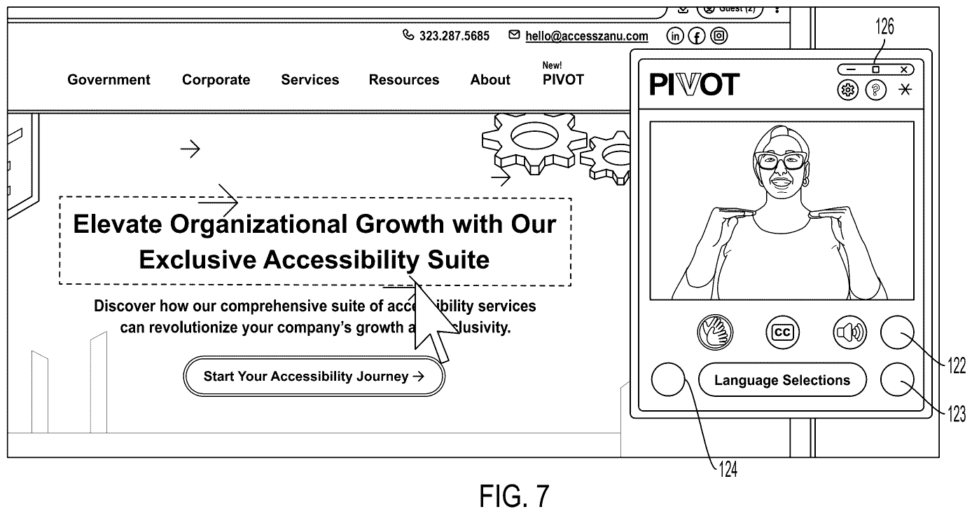

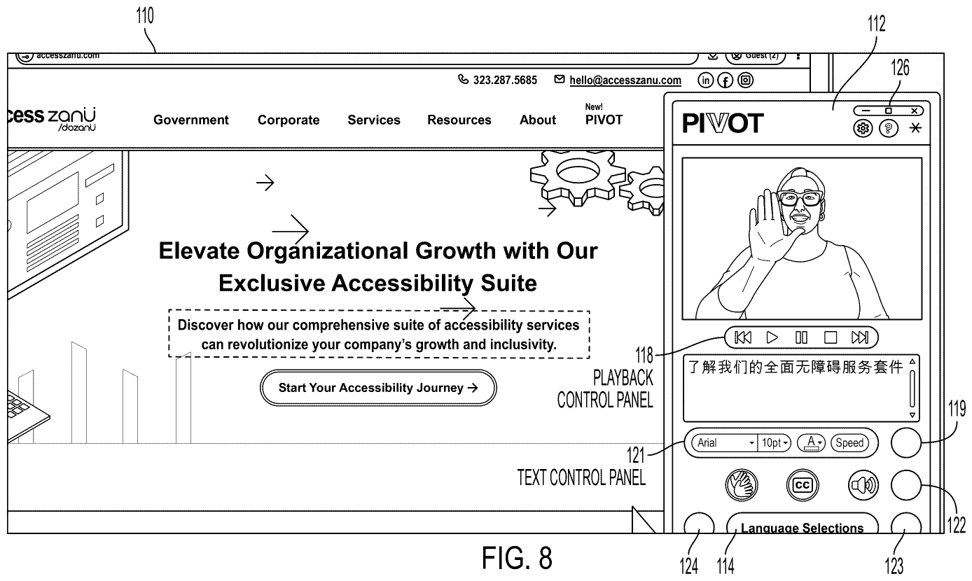

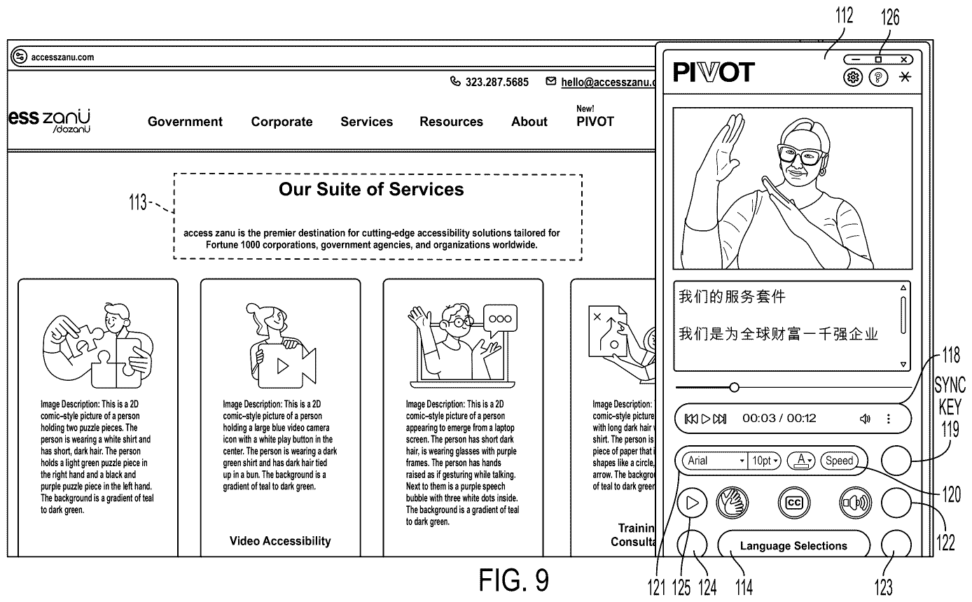

How the chosen translations 82 are displayed on the translation display window 112 may depend on the type of translation 82 chosen. For example, if a sign language translation 82 is chosen, the translation display window 112 may display a video recording of the specific translation 82 selected by the user 100 from the sign language translation dropdown menu 115 as depicted in FIG. 7. If transcription translations 82 are chosen, the translation display window 112 may display a transcription of the specific translation 82 selected by the user 100 from the transcription translation dropdown menu 116 as depicted in FIG. 9. And if an audio translation 112 is chosen, the translation display window 112 may play an audio translation of the specific translation 82 selected by the user 100 from the audio translation dropdown menu 117 as depicted in FIG. 8.

In some embodiments, such as those depicted in FIG. 8, multiple types of translations 82 may be displayed and played simultaneously. For example, a user 100 may choose American Sign Language, Spanish audio translation, and Chinese transcription for a particular piece of digital content 41. When multiple types of translations 82 are displayed simultaneously on the translation display window 112, the user 100 may, in some embodiments, independently control the playback of each translation 82 via one or more playback control panels 118. According to some embodiments, the playback control panel 118 lets a user 100 fast-forward, rewind, or pause all or a portion of the selected translation 82.

In other embodiments, such as that depicted in FIG. 9, the user 100 may wish to listen and watch all selected translations 82 simultaneously and in sync. To accomplish this, certain embodiments of the software plugin module 50 may include a sync key 119 which automatically aligns the playback of the selected translations 82 and keeps the playback of the translations 82 in sync with one another. In this example, a single playback control panel 118 controls the playback of all selected translations 82 simultaneously.

In addition to displaying the chosen translations 82, the translation display window 112 may also include various options to control how the translations 82 are displayed and other user control options. For example, the translation display window 112 may include a playback speed control option 120 allowing the user 100 to choose the playback speed of the video or audio translations 82. In some embodiments, the translation control window 112 may allow the user 100 to decide how large each translation 82 is displayed and to emphasize or minimize one specific translation 82 while the others are also displayed. Likewise, for transcription translations 82, the display window may include a text control panel 121 including various options allowing the user 100 to modify the text size, playback speed, color, and font type.

In some embodiments, the translation display window 112 may also include various other functions in addition to the translation features. For example, in some embodiments the translation display window 112 may include a request translation component 122 allowing a user 100 to request from the moderator 60 a translation 82 in a language not otherwise provided. Upon making this request, the software plugin module 50 sends a notification to the moderator interface 70 notifying the moderator 60 that a new translation 82 has been requested. In certain other embodiments, the translation display window 112 may also include a report component 123 to allow users 100 report inaccuracies in the translations 82 to the moderator 60. In some embodiments, the moderator 60 may receive the notification through the moderator interface 70, and can take appropriate action to correct as needed.

Other functionalities are also contemplated. For example, the translation display window 112 may include an instruction icon 124 which when clicked provides simple instructions on how to use, modify, or navigate one or more of the translation display window 112, the translation option menus 114, the playback control panel 118, and/or the text control panel 121. Likewise the translation display window 112 may include additional functions to control other various user interface aspects of the translation display window 112. For example, certain embodiments may include as autoplay control function 125 which would allow a user 100 to decide whether the translations 82 start automatically when chosen, or whether they are loaded into a queue and only start once the user 100 presses the play button on the playback control panel 118 or the text control panel 121. In certain embodiments, a user 100 may toggle a setting which automatically closes the translation display window 112 after a translation is completed, or first requires the translation 112 to repeat a set number of times. Likewise certain settings may include the option of automatically replaying the translation 82 a certain number of times, and automatically starting a translation 82 once a media component is chosen.

In some embodiments, particularly those in which the user 100 creates an account for the specific host media 40, the software plugin module 50 may be designed to allow the user 100 to save their translation preferences for later visits. In such example, the user's 100 specific languages and translation playback settings will automatically repopulate each time the user 100 visits, logs into, or uses the host media 40. However, the user 100 will still have the ability to change the settings each time they visit.

As described previously, the translation display window 112 also includes a window control bar 126 with controls for minimizing or closing out the translation display window 112. According to some embodiments, depending on the user's 100 specific settings, the translation display window 112 may remain open as the user 100 navigates through the host media 40, or automatically close after each translation 82 is played. In some embodiments, each time the user 100 selects a specific digital content 41, the translation display window 112 automatically populates the requested translation 82 into the translation display window 112 for presentation to the user 100.

In some embodiments of the present disclosure, the translation display window 112 may also include functionality to permit a user 100 to change one or more visual aspects of the digital content 41 presented on the host media 40. For example, through the user interface 110, the user 100 may select one or more discrete portions of the digital content 41 to apply accessibility or visual adjustment features to. In such embodiments, accessibility adjustments (for example, increased contrast, color inversion, font enlargement, or alternative font presentation) may be applied only to the selected portion of the digital content 41, rather than to the entire host media 40. This selective adjustment allows users to enhance readability or accessibility in a more targeted manner, without altering the overall display or layout of the host media 40.

In one example use case, a warehouse management system (the host media 40) may be displayed in a mixed-language environment, where a supervisor views the user interface 110 in English while an employee accesses information in Spanish. In such an embodiment, the presented system may permit translation or visual adjustment of only a specific piece of digital content 41 (e.g., a specific field, table cell, or data entry section), thereby allowing both the employee and the supervisor to work collaboratively within the same user interface 110 without globally changing the interface language or device settings.

In another example, a visually impaired user 100 may wish to invert colors or increase text contrast only within a specific region of the host media 40 that contains low-contrast text adjacent to a graphic or image, thereby improving legibility of that portion without applying a site-wide contrast inversion. Similarly, a user 100 may selectively enlarge the font size for a single section of digital content 41 (such as text, label, or interface element) to improve visibility or comprehension, while maintaining the overall visual proportions of the surrounding content.

In certain implementations, the translation display window 112 or user interface 110 may include interactive controls, such as contextual menus, highlight-based selection tools, or toggle buttons, enabling the user 100 to designate a desired region or text segment (the digital content 41) and apply one or more visual accessibility features in real time. These features may be configured through the software plugin module 50 so that they can dynamically modify the appearance of the selected digital content 41 without requiring reloading or re-rendering of the entire page.

In certain embodiments, the systems and methods described herein may further be implemented within a live chat or chatbot interface operating on the host media 40. In such embodiments, the translation display window 112 and associated accessibility features may be dynamically applied to text generated or received within a live messaging environment, such as, for example, a customer service chatbot. For example, a user 100 may engage in a real-time conversation with another participant or with an automated chatbot, wherein each message, or portion thereof, can be individually translated, reformatted, or visually adjusted according to the user's 100 preferences through the translation display window 112. The system may permit selective translation or visual modification of specific chat messages or message threads into one or more target languages without requiring conversion of the entire chat interface.

In some examples, the live chat interface may display both the original and translated text simultaneously, either in-line or within the translation display window 112, allowing multi-language users to collaborate or communicate seamlessly. Additionally, the user 100 may selectively apply accessibility adjustments to one or more pieces of digital content 41—such as enlarging or highlighting only one message bubble, altering the background contrast of a particular message region, or adjusting font styles for a subset of messages-to enhance visibility or comprehension of the translated digital content 41 in real time.

In certain embodiments, the chat interface may also support multi-modality of translations, wherein textual, audio, and visual representations of translated content are provided concurrently. For instance, a user 110 may receive an audio playback of a translated message while the corresponding text is displayed in a high-contrast or enlarged format depending on the user's 100 preferences. This functionality allows accessibility and translation features to operate together across multiple communication modalities within the host media 40, enabling flexible interaction without disrupting the layout or formatting of other chat elements.

In further embodiments, the translation display window 112 may be configured to provide real-time translation of live or continuously updating digital content 41 through a variety of host medias 40. Such digital content 41 may include, for example, live-streamed media, video conferences, webinars, online broadcasts, live chat feeds, sports commentary, financial news updates, public speeches, or other dynamically generated audio or text sources. In such embodiments, the presently disclosed system may employ an artificial intelligence (AI) translation engine, a real-time human translator, or a hybrid combination thereof to generate translations 82 of the live digital content 41 as it is received.

In certain embodiments, the system may interface directly with one or more real-time human translators who provide live translation services for digital content 41. For example, the software plugin module 50 may establish a secure connection between the host media 40 and a remote translator terminal, permitting a human translator to view or listen to the live digital content 41 in real time and input corresponding translations 82 for real time display on a user interface 110.

In some implementations, the system may support hybrid operation, wherein the AI translation engine initially generates an automated translation of the live digital content 41, while a human translator simultaneously monitors and corrects or refines the AI output before or after display. This configuration may provide enhanced translation accuracy and contextual precision while maintaining low latency suitable for live events.

In another example, multiple human translators may participate concurrently, each assigned to specific languages, speakers, or content segments, with the software plugin module 50 dynamically routing portions of the live digital content 41 to the appropriate human translator. The moderator 60, through the moderator interface 70, may manage translator assignments, monitor translation 82 quality, or manually override AI-generated translations when a live translator feed is available. The user interface 110 may further include an option for the user 100 to select a preferred translator or translation mode (e.g., “AI only,” “Human live,” or “Hybrid verified”), allowing real-time customization of translation source, type, and speed.

In some embodiments, the real time translations 82 of the digital content 41 may be rendered within the translation display window 112 in various modes, such as real-time captioning, overlaid subtitles, side-by-side text presentation, or audio playback of a translated voice stream. The software plug in module 50 may automatically detect the language of the live digital content 41 and begin translation without requiring manual input from the user 100. In other embodiments, the moderator 60 may preemptively select live digital content 41 through the moderator interface 70 so that the user 100 has the option when interacting with the host media 41 to decide if and how the live translations are displayed. In certain embodiments, the software plugin module 50 may also dynamically adapt to speaker changes, context shifts, or domain-specific terminology (e.g., sports statistics, technical jargon, or product specifications) to maintain accurate and context-aware translations.

In some embodiments, the software plugin module 50 may further allow a user 100 to toggle between machine-generated and human-provided translations 82, or to designate that certain segments of live content be translated by one mode or the other. This flexibility may allow for a balance between translation speed and linguistic accuracy, depending on the nature of the live digital content 41. In addition, the system may permit accessibility customization of the live translated content-such as increasing font size, altering color contrast, or adjusting playback speed-through the same user interface 110, ensuring that real-time translation remains accessible to users with diverse visual or auditory needs.

While various embodiments of the present disclosure have been described in detail, it should be apparent that modifications and variations thereto are possible, all of which fall within the true spirit and scope of the disclosure. For example, while the present example describes use of the software plugin module in a website, embodiments of the software plugin module may be implemented into any digital platform which utilizes an interactive user interface, including but not limited to mobile apps, ATMs, smart home devices, car dashboards, gaming consoles, medical equipment, industrial machinery, and customer service kiosks.

Likewise, while sign language, audio, and closed captioning translations are contemplated with the present example, other embodiments may utilize other forms of available translations including adaptive translations.

Therefore, the foregoing is intended only to be illustrative of the principles of the disclosure. Further, since numerous modifications and changes will readily occur to those skilled in the art, it is not intended to limit the disclosure to the exact construction and operation shown and described. Accordingly, all suitable modifications and equivalents may be included and considered to fall within the scope of the disclosure, defined by the following claim or claims.

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising” when used in this specification, specify the presence of stated features, steps, orientations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the relevant art. It will be further understood that terms, such as those defined in commonly used dictionaries, should be interpreted as having a meaning that is consistent with their meaning in the context of the relevant art and the present disclosure and will not be interpreted in an idealized or overly formal sense, unless expressly so defined herein.

It will be appreciated that any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing, including a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all be referred to herein as a “circuit,” “module,” “component,” or “system.” Furthermore, aspects of the present disclosure may take the form of a computer program product embodied in one or more computer readable media having computer readable program code embodied thereon.

It will be appreciated that all the disclosed methods, components and procedures herein can be implemented using one or more computer programs or components. These components may be provided as a series of computer instructions on any conventional computer-readable medium, including RAM, SATA DOM, or other storage media. The instructions may be configured to be executed by one or more processors which, when executing the series of computer instructions, performs or facilitates the performance of all or part of the disclosed methods and procedures.

Unless otherwise stated, devices or components of the present disclosure that are in communication with each other do not need to be in continuous communication with each other. Further, devices or components in communication with other devices or components can communicate directly or indirectly through one or more intermediate devices, components, or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on a user's computer, as a stand-alone software package, partly on a user's computer and partly on a remote computer or entirely on the remote computer or server.

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process, and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

It will be understood that a number of techniques and steps relating to the disclosure are presented. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the present disclosure and the claims.

What is claimed is:

1. A computer program comprising:
a non-transitory computer-readable medium with computer-readable instructions
encoded thereon wherein the computer-readable instructions, when processed by a processing device instruct the processing device to perform a method of managing, controlling, and displaying one or more multi-modal translations comprising:
a moderator interface at a first location configured for a moderator to:
view a host media in a native format;
isolate individual digital content components;
select one or more individual digital content components for translation;
upload one or more translations of the one or more digital content components into a repository; and
link a specific translation from the repository to one or more individual digital content components;
a user interface at a second location configured for a user to:
view the host media in the native format, and view and interact with
a translation display window to select one or more translations of the individual digital content components for visual or auditory representation from the translation display window; and
a plugin software module, wherein a first interface between the plug-in software module and the moderator interface, and a second interface between the plug-in software and the user interface enables the moderator interface to directly display the translation display window and translations onto the user interface.

2. The computer program of claim 1 wherein the host media includes content displayed on an interactive electronic display.

3. The computer program of claim 1 wherein the digital content components are comprised of:
a text segment;
an audio clip;
a video clip;
an image file;
a form;
a file; and
any combination thereof.

4. The computer program of claim 1 wherein the translations are uploaded as a file to the database through the moderator interface and are comprised of:
an audio translation in any language;
a text translation in any language;
a sign language translation in any language; and
any combination thereof.

5. The computer program of claim 1 wherein the translation display window is an interactive window displayed on the user interface comprising:
a dropdown option displaying one or more available translation options;
a display window for displaying the one or more translations;
a display window control option for adjusting the size and location of the translation playback, and
a control bar for controlling the translation playback including the speed at which the translation is played and the progress of the translation.

6. The computer program of claim 1 wherein access to the moderator interface requires a moderator to enter the necessary credentials provided by the digital content owner comprising:
a username and password;
an email address and password;
a phone number and password;
a single sign-on system; and
any combination thereof.

7. The computer program of claim 1 wherein the moderator interface allows a moderator to upload, store, and remove translations from a database at a third location.

8. The computer program of claim 1 wherein the user interface allows a user to request from the moderator, translations for any media component for which no translations are currently available.

9. The computer program of claim 1 wherein the user interface sends a notification to the moderator interface when a request for a translation is received.

10. The computer program of claim 1 wherein the moderator interface sends a request directly to a user when a requested translation becomes available on the user interface.

11. The computer program of claim 1 wherein the plug-in software module includes utilities that enable the plug-in software module to generate and display textual translations across a variety languages using machine translation when no translations exist.

12. A method of displaying multi-modal translations for digital content, the method comprising:
displaying a moderator interface for viewing the host media in native format, isolating individual digital content components from the host media, receiving instructions to select one or more individual digital content components for translation, receiving one or more translations of the digital content components into a repository, and receiving instructions to link specific translations to individual digital content components; and
generating a display of the host media in the native format and a translation display window on an interactive screen for a user to select one or more translations for visual or auditory representation from the translation display window.

13. The method of claim 10 further comprising enabling a first interface between the plug-in software module and the moderator interface and a second interface between the plug-in software module and the user interface enabling the moderator interface to directly display the translation display window toolbox onto the user interface.
